(19) United States
(12) Patent Application Publication
(10) Pub. No.: US 2009/0077373 A1
(43) Pub. Date: Mar. 19, 2009

(54) SYSTEM AND METHOD FOR PROVIDING VERIFIED INFORMATION REGARDING A NETWORKED SITE

(75) Inventor: Glenn A. KRAMER, San Francisco, CA (US)

Correspondence Address: YOUNG & THOMPSON, 209 Madison Street, Suite 500, ALEXANDRIA, VA, 22314, US

(73) Assignee: COLUMBUS VENTURE CAPITAL S. A. R. L., Bellevue-Geneva (CH)

(21) Appl. No.: 12/209,220

(22) Filed: Sep. 12, 2008

Related U.S. Application Data
(60) Provisional application No. 60/971,968, filed on Sep. 13, 2007.

(51) Int. Cl. G06F 21/00; H04L 9/00

(52) U.S. Cl. 713/155; 713/176

(57) ABSTRACT

A system and method are disclosed for presenting a message relating to a networked site on an end-user device, the message preferably originating from a third party that is not a provider of the site. The end-user device receives a message blob containing the message and associated verification information when the networked site is accessed. A verification application then sends a request to verify the authenticity of a message blob to a verification server. If the verification server verifies that the message blob is authentic based on the verification information, presentation of the site-specific information on the end-user device is enabled.

### CROSS-REFERENCE TO RELATED APPLICATION

This application claims the benefit of priority of U.S. Provisional Patent Application No. 60/971,968 filed Sep. 13, 2007, the entire contents of which are incorporated herein by reference.

### FIELD OF THE INVENTION

The present invention relates to a system and method for verifying the authenticity and credentials of information presented on networked sites, especially World Wide Web sites. More particularly, it relates to a system and method for providing different types of verified information about a specific provider site to a user of that a site.

### BACKGROUND OF THE INVENTION

There have been many attempts to provide for the security of consumers and other Internet users transacting business or gaining/providing access to confidential information on Web sites. An underlying goal of these schemes is to verify the identity and other specific information (such as membership in trade organizations or authorized retailer status) of the Web site provider, and thereby to reassure users that they can trust the site provider for e-commerce transactions or as a provider or recipient of confidential information.

In one such scheme, Extended Validation Certificates (described for instance at http://en.wikipedia.org/wiki/Extended_Validation_Certificate) are issued by a trusted authority to a Web site provider after the provider has undergone a thorough evaluation of its business credentials. This typically includes examination of items such as articles of incorporation, business licenses, and credit reports by the trusted authority. Unfortunately, such evaluations can be costly, and they are still vulnerable to sophisticated cons or spoofs. In addition, a site operator may continue to have a valid business license even though other important business credentials have changed. For example, a site may no longer: meet the service requirements to sell a particular brand, be able process transactions using a certain type of credit card, or be a member in good standing with a trade association. In these situations, the Extended Validation Certificate would still generally remain valid.

In a similar vein, the QUATRO Project (www.quatro-project.org) places labels on sites such as “fair commercial practices will be used on this site.” Sites can be adorned by a number of labels, which are written using the Resource Description Framework (RDF) notation of the Semantic Web (see for instance, http://en.wikipedia.org/wiki/Resource_Description_Framework). QUATRO's labels can be stored locally on a Web site or with a Labeling Authority. In either case, verification of the labels proceeds through the QUATRO Proxy, referred to as QUAPRO. This is a computationally expensive and potentially time-consuming solution, since the proxy must retrieve the URL (separately from the client machine retrieving it), parse the RDF on the page, retrieve any labels from the site or Labeling Authority, and then verify them. The time required to do this depends heavily upon available network bandwidth. Additionally, this process may be spoofed, for example, by a malicious site learning the IP addresses of the QUAPRO sites, and sending the QUAPRO sites different content than it would actual users. In particular, QUATRO also does not enable the signing of content labels that are generated.

There is therefore a need for an improved verification system and method that is able to present provider or site-specific information to users in an efficient, up-to-date, and highly secure manner.

### BRIEF SUMMARY OF THE INVENTION

The present invention relates to such a system and method for presenting a message relating to a networked site on an end-user device.

In one aspect the invention provides a system including a verification application comprising computer-readable program code residing on an end-user device a verification server, remote from the end-user device and a verification server that is remote from the end-user device. The verification application is configured to send, via the network, a request to verify the authenticity of a message blob received by the end-user device when said end-user device accesses the networked site, and to enable presentation of the message on the end-user device upon receiving a return message confirming that the message blob is verified as authentic. The message originates from a third party (or trusted party) that is not a provider of the networked site, and the message blob contains the message and associated verification information. The verification server is configured: to receive, via the network, the request to verify the authenticity of the message blob from the verification application; to verify whether the message blob is authentic based on the verification information; and to send the return message confirming authenticity to the verification application if the message blob is verified as authentic.

In a preferred embodiment, the verification server is remote from servers of both the third party and the provider of the networked site.

When accessing the networked site, the end-user device may receive the message blob directly from the third party. Alternatively, the end-user device may receive the message blob from the provider as part of the content of the networked site.

Preferably, the associated verification information is generated, at least in part, from digital signature software and secret information provided to the third party by or on behalf of the verification server. The associated verification information may comprise information relating to the identity of the third party, information relating to the identity of the provider of the networked site and a digital signature. To verify whether the message blob is authentic, the verification server may determine the secret information provided to the third party based on the information relating to the identity of the third party and then use that secret information to evaluate the associated verification information.

The request to verify the authenticity of the message blob may comprise a verification blob that is identical to the message blob or that, alternatively, contains a hashed value of the message. The return message confirming authenticity may also comprise a hashed value of the message.

Preferably, the verification application is further configured to send, to the verification server, a request to verify the authenticity of the networked site together with identity information about the networked site. In this case, the verification server is further configured to verify whether the networked site is authentic prior to verifying whether the message blob is authentic.

In another aspect, the present invention provides a method of presenting a message relating to a networked site on an end-user device comprising: receiving from the end-user device, at a verification server remote from the end-user device, a request to verify the authenticity of a message blob, the message blob having been received at said end-user device when the end-user device accesses the networked site. The message originates from a third party that is not a provider of the networked site, and the message blob comprises the message and associated verification information. The method further comprises verifying at the verification server whether the message blob is authentic based on the verification information and, if the message blob is verified as authentic, sending a return message confirming authenticity to the end-user device so that the message can be presented on the end-user device.

In a further aspect the present invention provides a method of presenting a message relating to a networked site on an end-user device, the method comprising, when the end-user device accesses the networked site, receiving a message blob containing the message and associated verification information. Again, in this case, the message originates from a third party that is not a provider of the networked site. The method further comprises sending a request to verify the authenticity of the message blob to a verification server that is remote from the end-user device, and, if the message blob is verified as authentic by the verification server, enabling presentation of the message on the end-user device.

In yet another aspect the present invention provides a method of presenting a message relating to a networked site on an end-user device. Here, the method comprises transmitting the content of the site to the end-user device and further initiating transmission of a message blob to the end-user device when a request to serve content of a networked site is received from an end-user device. Again, in this case, the message originates from a third party that is not a provider of the networked site, and the message blob comprises the message and associated verification information. The method further comprises embedding within the content of the networked site a link to invoke a verification application residing on the end-user device, the verification application being configured to communicate with a verification server to enable the server to verify that the message blob is authentic based on the verification information. Upon the message blob being verified as authentic, the message can be presented on the end-user device as part of the content of the networked site.

The message blob may be served to the end-user device as part of the content of the networked site. The message blob may also be generated dynamically upon receiving the request to serve the content of the networked site and thereafter inserted as part of the site content. Alternatively, initiating transmission of the message blob to the end-user device may comprise sending a request to the third party to send the message blob directly to the end-user device. In another embodiment, initiating transmission of the message blob to the end-user device comprises embedding within the content of the networked site a request to invoke the verification application on the end-user device to further request the transmission of the message blob directly from the third party.

### BRIEF DESCRIPTION OF THE DRAWINGS

The objects and advantages of the present invention will be better understood and more readily apparent when considered in conjunction with the following detailed description and accompanying drawings which illustrate, by way of example, preferred embodiments of the invention and in which:

FIG. 1 is a block diagram showing a general overview of a site verification system suitable for use in combination with the present invention;

FIG. 2 is a ladder flow diagram depicting communication between the entities in the system of FIG. 1 in accordance with a first verification method;

FIG. 3 is a ladder flow diagram depicting communication between the entities in the system of FIG. 1 in accordance with a second verification method;

FIG. 4A is an example of a seal icon including user-customized information;

FIG. 4B is an example of a provider's Web page that has been authenticated by the system of FIG. 1 and displays the seal icon of FIG. 4 and supplementary verification information to a user;

FIG. 5 is a block diagram illustrates, in accordance with preferred embodiments of the present invention, a system for providing different types of verified information about a specific provider site that information originating at one or more trusted parties and being verified by a seal server;

FIG. 6 shows the step of message blobs containing the site-specific information being communicated from the trusted parties to a content provider in the system of FIG. 5;

FIG. 7 illustrates the step of a user downloading a Web page with the message blobs from the provider in the system of FIG. 5;

FIG. 8 shows a variant of the step in FIG. 7 in which the provider gathers data from the trusted parties in real-time for inclusion in the messages;

FIG. 9 illustrates the step of the user requesting a seal application from the seal server;

FIG. 10 illustrates the step of the seal server transmitting the seal application to the user;

FIG. 11 shows the step of the seal application verifying whether the provider site is authentic;

FIG. 12 illustrates an alternative embodiment in which the seal application receives a message blob directly from a trusted party;

FIG. 13 shows the step of the seal application requesting verification of the message blob;

FIG. 14 shows the verification step being carried out by a verifier module at the seal server;

FIG. 15 illustrates the verification step of FIG. 14 in more detail; and

FIG. 16 illustrates the step of the seal application informing a user whether the verification as successful and, if so, presenting the site-specific information.

### DETAILED DESCRIPTION OF PREFERRED EMBODIMENTS

The present invention addresses the above-described disadvantages of the prior art by providing a system and method to enable trusted parties to present information to an Internet user indicating that the site the user has accessed meets the standards that one or more trusted parties have set in order for the site to have a business, commercial, or trade relationship with those trusted parties.

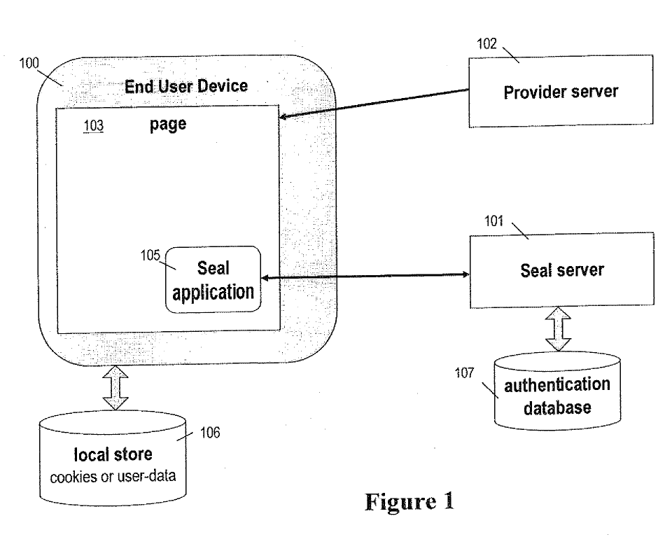

In accordance with the invention, the user is first preferably provided with verification that the provider of the site being accessed is authentic, i.e., that the provider of that site is the company or organization that it claims to be. In a preferred embodiment, this occurs using the system and method of co-pending and commonly-assigned U.S. patent application Ser. No. 11/850,805 filed Sep. 6, 2007 and entitled “System And Method For Verifying Networked Sites”, the entire contents of which are incorporated herein by reference. Selected portions of this application—notably FIGS. 1-4 and the description corresponding thereto—have been largely reproduced below for completeness.

Generally, in accordance with the system and method invention described in the above-referenced patent application, user-customized information such as an image, application skin, or audio clip is selected by the user to provide an indicator that clearly belongs to that particular user. The user-customized information is encrypted and stored on the end-user device. The user-customized information is only decrypted and presented to the user once the site under question has been authenticated, and the user need not perform any other action (such as clicking-through) to verify the site.

FIG. 1 is a block diagram providing a general overview of a system for verifying the authenticity of network sites, in particular World Wide Web sites, using customized information recognizable to a user. As shown in FIG. 1, an end-user device 100 is configured to receive and display the content of a page 103 that is downloaded over a network from a networked site provider's server 102. As is well known, the network is typically the Internet, and server 102 is typically a Web server. Provider server 102 may be the Web server for a bank, e-commerce site, or other site intended to exchange confidential information with users. End-user device 100 is the combination of hardware and software used by a user to view network or Internet content, for instance a personal computer, mobile telephone, or other networked device running browser software such as Mozilla Firefox™.

As shown, part of the content of page 103 references a verification (or “seal”) application 105 that is to be invoked locally on the end-user device 100 or downloaded from a verification (or “seal”) server 101. In some embodiments, the seal server 101 may be the same server as (or otherwise related to) provider server 102, however seal server 111 is preferably run by a trusted party that is independent of the provider and thus located at a different network location on the Web so that it is remote (i.e., at a different, unrelated network address) from provider server 102. In this manner, several different provider servers 102 may take part in the verification system. It will also be appreciated that seal server 101 may for example comprise a plurality of server systems operated by the same party (or related parties), and that such server systems may or may not be physically located at the same location or network address (and in fact for traffic-handling purposes it may be preferable to disperse them geographically). The end-user device has local storage 106—which in some embodiments may be the local file system (where permitted)—containing user-specific information such as browser cookies, Flash Shared Objects, or other user data. As shown in FIG. 1, seal server 101 also preferably has secure access to authentication database 107 containing information about authentic or “genuine” provider sites.

In a preferred embodiment, and in a similar manner to known trust/authentication schemes, a provider site wishing to participate in the verification system “registers” with the verification authority running seal server 101 and, upon approval, information relating to that provider site (notably its true domain name and IP addresses) is stored in database 107. However, in other embodiments, the verification server need not have any pre-existing information about a provider site, and instead simply verifies that a site is who it says it is (and in this case authentication database 107 may not be used).

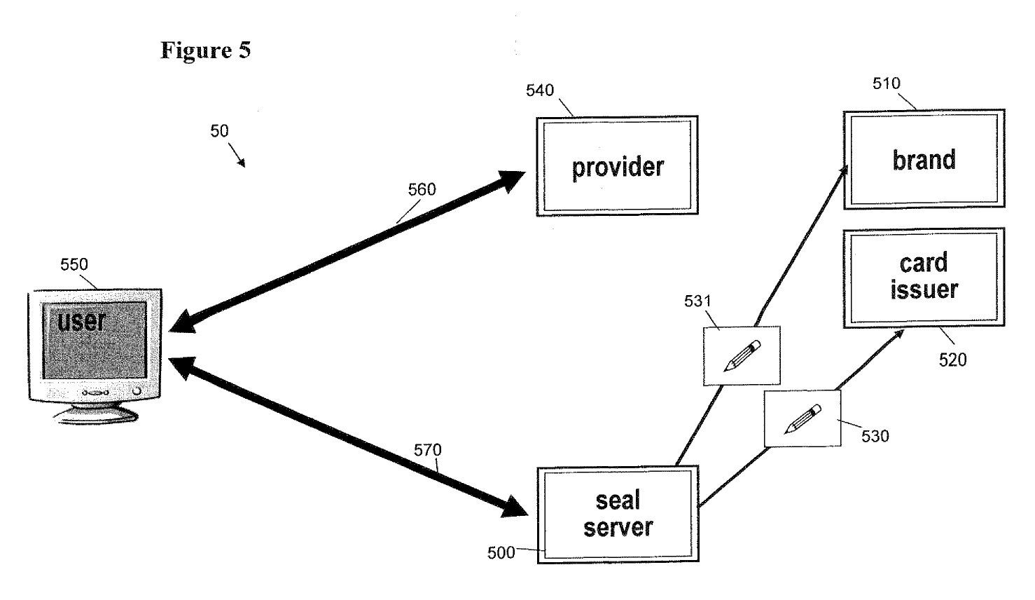

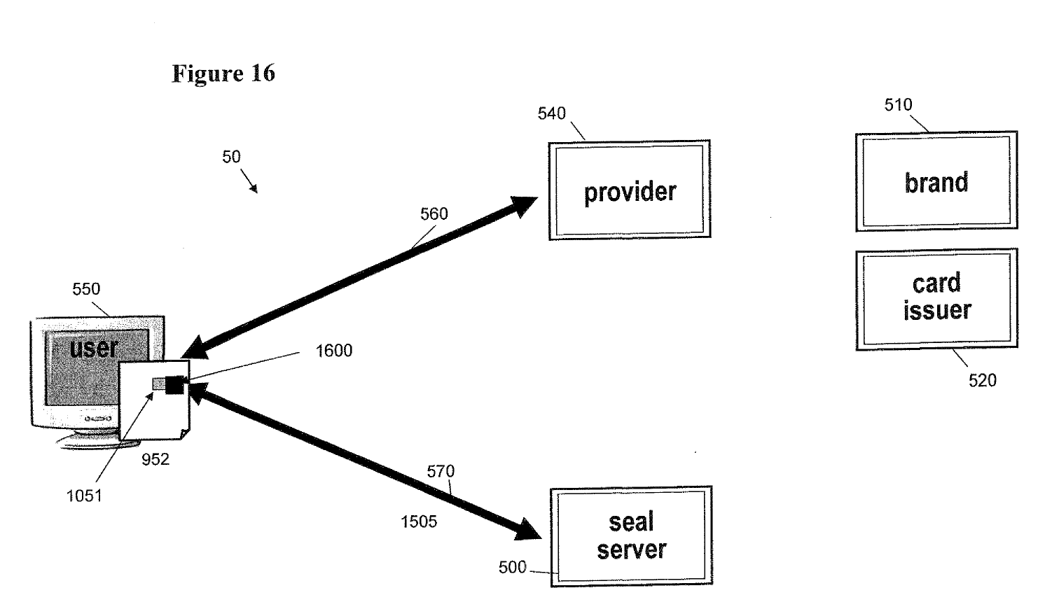

Initially, the verification or seal application (or “seal”) 105 may be dynamically downloaded from a trusted third party source (typically affiliated with the verification server 101) or otherwise installed on the user's computing device 100. As will be explained further below in connection with FIGS. 5 and 16, prior to effecting any verification of a provider site, the user preferably configures seal application 105 by selecting user-customized information (such as an image, “skin”, and/or audio clip) that is encrypted and stored locally in 106 on device 100 (or is otherwise locally accessible to the end-user device, e.g., on an associated local area network). Preferably, and as described further below, seal server 101 has no access to or any specific knowledge of this user-customized information. Although the user must carry out this initial configuration step to enable device 100 to operate in the site verification system, there is no need for the user to register with, or otherwise provide any personally identifiable information to, the seal server (or any other party) in order to install seal application 105. As described below, in alternative embodiments, the initial configuration of the user-customized information may alternatively be carried out by a customized information editor application that is related to (or forms a sub-component of) the seal application.

Preferably the user-customized information includes some type of multimedia content such as an image, video, and/or audio clip, although a simple alphanumeric password could also be used. By allowing each user to personally select this customized information (for instance, the user may choose a picture of himself, a family member, or a pet or an audio recording of his choosing such as a mobile ringtone-like audio clip), each user can select information that is immediately recognizable and has long-term memory retention for the user. Alternatively, the user-customized information may be generated and assigned by the seal application running on the end-user device (for example, on a pseudo-random basis), again preferably without the seal server 101 having any record of this information.

As described below, seal application 105 is invoked in response to a request encoded within a provider's network-accessible content. Once invoked, the seal application can then initiate verification of the authenticity of a provider site in the manner described below. When it has done so, the seal displays, plays or otherwise presents the user-customized information to inform the user that the site's seal is genuine and not just an image copied from another Web site.

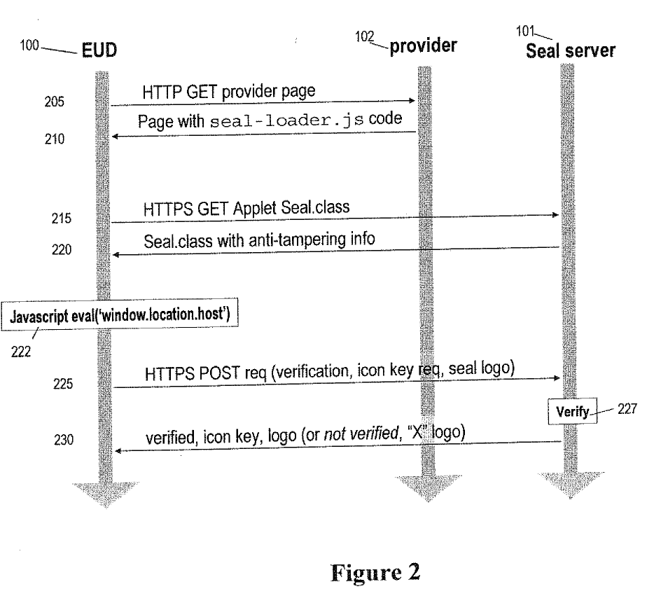

FIG. 2 depicts the communications between end-user device 100, provider server 102 and seal server 101 as a ladder flow diagram. As an initial step (not shown), the user configures his device by selecting user-customized verification information as described above. At step 205, end-user device 100 downloads a page from provider server 102. As noted, provider server 102 may belong to an e-commerce site, a financial institution or any other entity dealing in confidential or sensitive information, be it financial or otherwise. In order for the provider to establish to the user that the page is authentic, at 210, provider server 102 serves the content of a provider's page together with a link to the seal application 105, thereby effectively embedding the seal application in the content of the served page.

In one embodiment, seal application 105 is already resident on the end-user device having been fully downloaded by the user during the initial configuration stage. Alternatively, the user may only download a related customized information editor application (which may or may not be a component of seal application 105) that enables the selection and any initial configuration of the user-customized information, and the page served by provider server 102 includes instead a link to download application 105 from seal application server 101. This latter option, shown in FIG. 2, is preferable where it is desirable to ensure that only the latest version of seal application 105 is used for verification purposes. Anti-tampering techniques may be used to ensure that only recently downloaded applications can communicate back to the seal server if such communication is needed.

In the illustrated embodiment of FIG. 2, seal application 105 is downloaded each time it is used (in the form of a Java applet or Flash SWF file, as two examples), and the code for invoking the application is stored in a Javascript file, called seal-loader.js that is served together with the provider page. As will be appreciated, other types of code could also be used, for e.g., Macromedia Flash objects. If needed, the end-user device can alternatively request the seal-loader.js code from seal server 101. At step 215, end-user device 100 then requests the actual application from seal server 101. The seal server 101 responds with executable code in response 220. As will be appreciated by those skilled in the art, the requests to seal server 101 preferably include anti-tampering technology, so that seal server 101 may check requests for validity (using the anti-tampering technology) before responding to requests from the downloaded seal application.

Generally, once invoked, seal application 105 collects identity information about a provider site and then forwards this information to seal server 101. The identity information may include (but is not limited to) the value of the browser state variable window.location.host, the name associated with an SSL certificate or a session challenge/response pair. Depending on the nature of the identity information received by seal server 101, it may then verify that the true domain name and/or IP address of a provider's site is authentic or genuine in various different ways.

In one embodiment, in order to allow seal server 101 to carry out authentication, seal application 105 uses JavaScript to determine the value of the variable window.location.host in the browser's object model, as shown in step 222. As will be appreciated, this value cannot be easily spoofed, because changing it has the side effect of changing the page the end-user's web browser is visiting. In addition, to provide a more secure level of authentication where the provider server has an SSL certificate, seal application 105 may invoke the browser to request the provider page by using the HTTPS protocol rather than HTTP in steps 205 and 210. In this case, if the hostname or domain name associated with the certificate does not match the hostname from window.location.host, the identity of the provider will not be confirmed or authenticated. An alternative to using the value of window.location.host is to use the value of document.location.host, which in modern browsers is a read-only property.

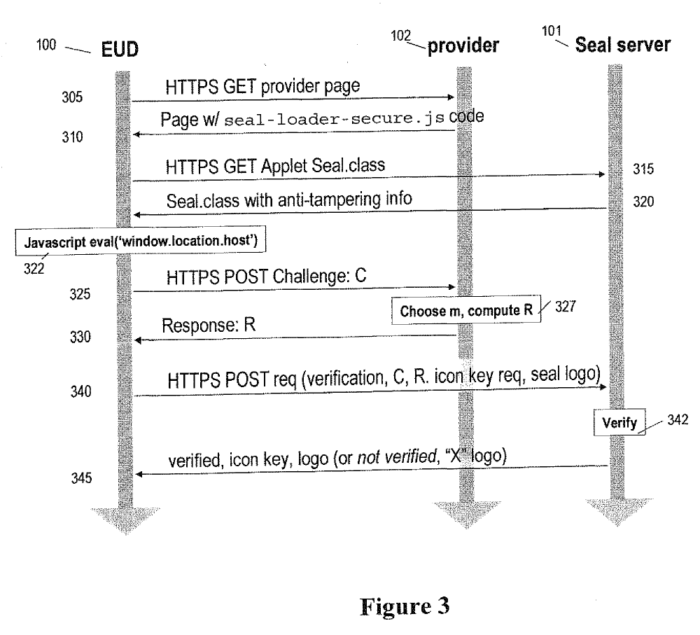

As will be appreciated by those skilled in the art, sophisticated attacks on a DNS system such as DNS poisoning (which is described in the Web entry http://en.wikipedia.org/wiki/DNS_cache_poisoning, the contents of which are incorporated herein by reference), may allow a non-authentic Web page to appear in a browser with an incorrect window.location.host variable value. The use of SSL certificate data can circumvent most such attacks, although a very highly sophisticated attack in which DNS for SSL connections is properly resolved but non-SSL connections are otherwise “poisoned” may still theoretically be possible. For this reason, an embodiment using an even higher level of security (albeit with higher computational costs) is also described further below in connection with FIG. 3. Such higher security may be desirable for certain types of provider sites such as financial institution sites. Nevertheless, for most practical applications, the evaluation of window.location.host with or without SSL certificate data provides a reasonably secure level of authentication.

At step 225 of the illustrated embodiment, the identity information (window.location.host) of the provider server or host of the site accessed by the user is sent by application 105 to seal server 101 along with a request to enable decryption of the user-customized information. At step 227, seal server 101 verifies that the provider is an authorized provider per the information sent in message 225. In this embodiment, assuming verification requires that all genuine provider sites have “registered” with or at least be known to server 101, verification notably includes verifying that the value of window.location.host is found in authentication database 107. On the other hand, in another embodiment, verification server 101 may not have any pre-existing information about a provider site, and instead simply verifies that a provider site is who it says it is by ensuring that the hostname associated with window.location.host matches the hostname associated with the provider site's SSL certificate. In yet another embodiment, the seal server may provide an indication to the user of the level of verification the server was able to perform. For example, the server 101 may indicate a “yellow light” authentication when the provider site is not known to it (i.e., not in database 107) but otherwise provides an SSL certificate match, and a “green light” authentication when the site passes both of these checks.

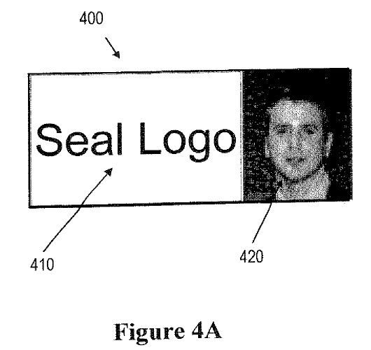

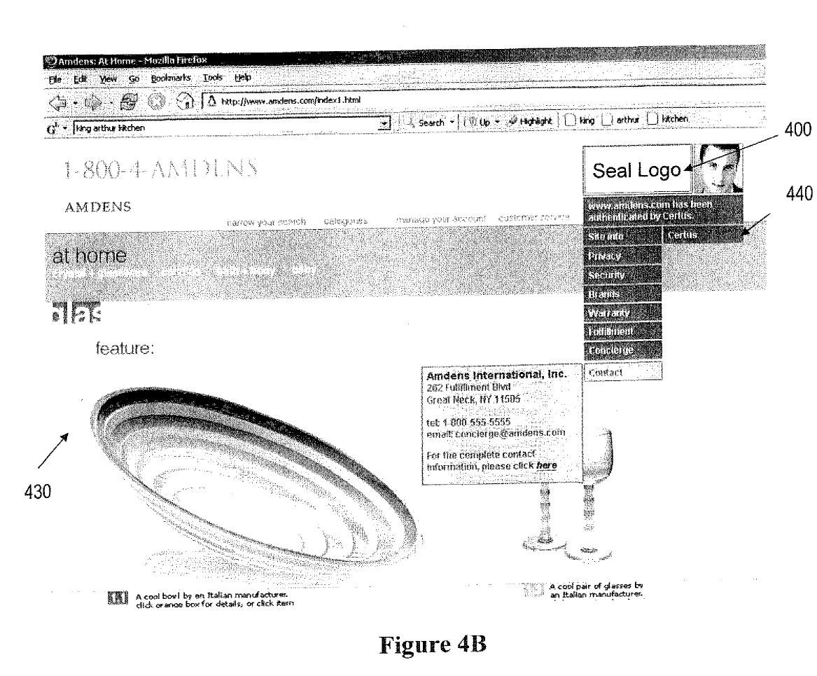

If server 101 verifies that the provider site is authentic, the seal application enables decryption of the user-customized information stored on the end-user device (as described below) so that this information can be presented to the user, preferably as part of the provider's page. In particular, in the illustrated embodiment of FIG. 2, server 101 responds in message 230 with verification status (i.e., whether verified or not), plus encryption keys to unlock or decrypt the encrypted user-customized information (assuming the site is verified as authentic). The end-user device then uses these keys to unlock this information and display a customized seal 400 (FIG. 4A) to the user.

As illustrated in FIG. 4 and described further below, the user-customized information may be presented to the user as a component of a seal 400. As shown in FIG. 4B, customized seal is preferably displayed as part of the content provider's Web page 430 and may include supplementary data 440 for the user. If verification is to be supplemented or confirmed by such additional provider-specific data or information 440 residing at the seal server site, a request for that data is sent to seal server 101 (along with the identity of the host as determined by window.location.host) prior to the unlocking of the encrypted information. This is shown at step 225 in FIG. 2 where the message contains requests for other optional information such as logos, provider policies, brands the provider is authorized to sell, etc. In this manner, the size of the seal application can be kept small, allowing information to be downloaded only when actually needed.

In some embodiments, enhanced security may be desirable and authentication of the provider may require more information than the identity information provided by either window.location.host or an SSL certificate. In particular, to more effectively combat DNS spoofing and other similar techniques, the provider 102 and seal server 101 may share an array of secret information, i.e., p_secret, that is out of band from the authentication process. These shared secrets can then be employed in a challenge/response fashion in the following manner, where the response to the challenge contains information that only the provider and the seal server are aware of and have access to. Here, the challenge and response are also sent by seal application 105 to the seal server 101 as identity information (or “identity credentials”).

For a challenge/response authentication of the provider, over either an HTTP or HTTPS connection, the value of a session cookie SC (shared between the seal server 111 and end-user device 100 and associated with the end-user device session) is used by the seal server 101 (or alternatively by seal application 105) to create a nonce that is cryptographically tied to the session cookie SC. For the case where the seal server creates the nonce, this can be done in the following manner:

nonce=Hash(secret[k]+Hash(SC))

where the secret array is known only to the seal server 101. The nonce is then used to create challenge C:

C=<k, nonce>

A provider response R to this challenge is as follows:

R<k, m, Hash(p_secret[m]+nonce)>

In the case where the seal application generates the nonce, this can be done as follows:

secret=Random( )

nonce=Hash(secret+Hash(SC))

C=<nonce>

R=<nonce, m, Hash(p_secret[m]+nonce>

The seal application in this case must also send the value of secret to the seal server in the verification request, so the seal server can check to make sure the nonce is tied to the session cookie SC. One skilled in the art will appreciate that these and related variants achieve the same goal, but with the computation distributed differently across the relevant parties.

Since the array of secrets p_secret is shared between the provider and seal server, the seal server can verify the identity of the provider. Furthermore, at any time seal server 101 can change or revoke the shared secrets should the provider no longer meet the authentication requirements. The indices k and m above allow for key rotation and maintenance. In some embodiments, the values of k and m may be identical, allowing for one less parameter in the system. This may be desirable if it is otherwise cryptographically acceptable.

FIG. 3 depicts the communications between end-user device 100, provider server 102, and seal server 101 as a ladder flow diagram, with the network verification system employing the above-described enhanced authentication steps. As in FIG. 2, end-user device 100 initiates a request to the provider server 102 for a page on which the provider wishes to include the authentication seal. For maximum security, this should occur over an HTTPS connection, as shown in request/response steps 305 and 310. In message steps 315 and 320, the end-user device requests and receives seal application 105 from the seal server 101. In step 322, seal application 105 communicates with the browser via JavaScript and evaluates window.location.host. The seal application 105 then uses this address to initiate a secure connection to the provider server 102 in which it posts the challenge at step 325. At step 327, the provider server computes the response R and sends it to the seal application in message step 330. In some cases, due to browser security restrictions (Same Origin Policy), the seal application may perform this request/response pair in JavaScript that has been injected into the provider's page 103. As will be appreciated by those skilled in the art, other alternatives to dealing with the Same Origin Policy may also be employed, such as multiple instances of a single Java applet sharing a static member field used for communication.

Still referring to FIG. 3, at message step 340, seal application 105 forwards R, along with a request for the user data keys and any other material it needs to display the seal, to the seal server. The seal server verifies the challenge/response and any other relevant data in step 342, and then returns the requested information, including decryption keys, in response message step 350. Provided the authentication was successful, the end-user device uses these keys to decrypt the user-customized information and to display the customized seal 400 to the user.

The above-described challenge/response steps occur as an interaction between seal application 105 and provider server 102, although seal server 101 may provide some assistance, such as providing application 105 with the nonce that is cryptographically tied to the seal application's session cookie with the seal server.

In an alternative embodiment, after receiving a request to verify a provider site from the seal application 105, the seal server 101 may generate and issue a challenge directly to the provider server without involving seal application 105. However such an embodiment may be more vulnerable to DNS cache poisoning attacks, and therefore is less preferred.

In the exemplary embodiment of FIG. 4A, the seal consists of two parts: a seal logo 410 and a user-customized icon/information 420 (e.g., a digital image of an individual). These are placed side-by-side in FIG. 4A, but the seal logo could alternatively be superimposed onto the user-customized image. More generally, it will be appreciated that FIG. 4A provides only an illustration of one possible embodiment of a seal 400 comprising two components: the trust logo 410 that may display the brand of the seal and the customized information 420, in this case an image. Since this icon/information is selected by the user and then stored securely and encrypted on the user's machine, it is very difficult for an attacker to create a replica seal. Audio can also be encrypted and programmed to play only if the provider site has been authenticated. Other kinds of customization, such as decorative borders or “skins,” can be selected, additionally or alternatively. These examples of user-customized information are illustrative only.

FIG. 4B shows the seal placed on a web site 430, with additional information 440 presented as the user moves the mouse over the seal. In this case the verification seal is also being used to provide information about the provider (i.e., the company that owns the Web site or on whose behalf it is run), including its privacy and security policies, the brands it is authorized to sell, and the contact information for the company. This additional information may be stored in database 107. Supplementary information 440 can be passed from the seal server to the end-user device and presented to the user when the user clicks on or moves the mouse over the seal 400.

Generally, however, the present invention provides an improved system and method of providing such site-specific supplementary information to users in an efficient, up-to-date, and highly secure manner. This will shortly be described in connection with FIGS. 5-16 below.

In the above-described site verification system and method, customized information or content resident on the end-user device 100 is unlocked and displayed only if the provider site has been authenticated. With the presentation of the customized information upon authentication, a user can rapidly and easily determine at a glance (or at a listen, if sound is employed) that the provider site is authentic. There is no confusion or uncertainty associated with examining address bars in browsers, checking for locked or unlocked padlock icons, or clicking-through to get verification information. Even consumers who are not sophisticated enough to examine a browser's security features are still able to verity the site's authenticity by simply determining whether or not their customized information is presented to them. Where that information or icon has personal meaning, for example a photo of one's self, family member, or pet, recognition is effectively automatic and the absence of the proper information or icon is readily ascertained.

Furthermore, the provider site is authenticated to the consumer prior to the consumer providing any personally identifiable information such as a username or password. The customized information is tied to the user's device rather than to the provider; and the same customized information can be used by a consumer to verify any provider site that participates with the seal server in the site authentication system. As a result, a user does not have to memorize different icons or sets of information for different providers.

In this manner, the user-customized information is not stored in nor is it accessible by a provider's server 102, and no preexisting relationship between the user and a Web site operator is required. In addition, the verification system and method works across multiple providers, preferably (but not necessarily) with a pre-existing relationship between each provider and the seal server. As a result, the system and method is well-suited for the authentication of a provider web site for all potential users, even if the users have no relationship with the provider and have never visited the provider's site before.

Thus, using identity information provided by the seal application 105, the seal server 101 acts as the authenticating entity, but importantly users are not required to register with the seal server as they are with authentication entities in prior art icon-based systems. The only initial step that a user must carry is the initial configuration of the user-customized information as described further in the incorporated U.S. patent application Ser. No. 11/850,805.

Generally, in the above-described verification system, seal application 105 and seal server 101 communicate with one another to enable both encryption and decryption of the user-customized information. Preferably, seal server 101 manages encryption keys for the user's customized information without ever needing to be in possession of or to store that information. This is also described in more detail in U.S. patent application Ser. No. 11/850,805.

Having described a preferred system for verifying that the provider of a networked (e.g., Internet) site is authentic, FIGS. 5-16 are block diagrams illustrating various communication steps in a system 50 for providing different types of verified information about a specific provider site to a user. System 50 includes a verification (or seal) server 500 and, in a preferred embodiment, additionally acts as a verification system for authenticating the provider 540 of a networked site to an end-user device 550—as just described above. The different types of verified site-specific information generally relate to the credentials and on-going operations of the provider 540 and may include for example (a) information about the brands of items or services that the provider site is authorized to sell, (b) information about the credit card brands that are accepted by the site, or (c) information about the general business practices of and/or consumer satisfaction with the site. More generally, as used herein, “site-specific” information may include any information that is relevant to the provider or the provider's site. This site-specific information originates from various parties—referred to herein as trusted parties—which may include brand owners 510, card issuers 520 (such as credit card companies or banks), and trade organizations.

In accordance with the present invention, system 50 enables the flow of such additional site-specific information about a provider 540 to the end-user device 550, preferably in the form of digitally signed messages. The seal application resident on the end-user device 550 relays a signed message containing site-specific information (or a hashed value thereof to the seal server 500 which in turn verifies that the information originates from a known trusted party and pertains to that particular networked site. In this way, the seal application on the end-user device serves as a conduit for all site-specific information pertaining to the networked site coming from trusted parties that have a relationship with provider 540.

Terminology-wise, any specific item (or set of items) of information relating to a provider's networked site is referred to herein as a message, and the collection of a message and associated verification information is referred to herein as a message blob. In one embodiment, the verification information comprises information relating to the identity of the third party, information relating to the identity of the provider of the networked site and a digital signature. The verification information may further optionally include expiration data. As described further below, the digital signature, which may comprise for example a verification token, can in turn be generated at least in part from the identity of the provider, the message, and a secret shared between the seal server and the trusted party.

These message blobs are not visible to an end-user, but are encoded in a non-viewable form such as a set of JavaScript variables. The message blobs themselves can be signed in advance by trusted parties and stored at the provider server 540. Alternatively, they can be generated dynamically and signed by a trusted party, and then inserted by the provider into the content of a page of the provider's networked site or, alternatively, sent directly to an end-user device.

Referring to FIG. 5, an example of the seal server 500 interacting with two trusted parties—a brand owner 510 and a credit card issuer 520—is illustrated. In practice, the certification of a networked site by a brand may be delegated by the brand to an entity in its distribution channel, and similarly certification by a card issuer may be delegated to a member bank that has an explicit financial relationship with the provider. For the purposes of the invention, the interactions are functionally equivalent regardless of whether or how such delegation is done. Furthermore, the trusted parties 510 and 520 in the illustrated embodiments are exemplary only; in general, there may be any number of trusted parties in system 50, and there may also be a hierarchy of trusted parties.

Preferably, the provider server, trusted party server(s), and seal server are all located remotely from one another on the network and are operated by independent parties. However, in some cases, the provider 540 may itself act as a trusted party. Still in other cases, the seal server 500 may be a trusted party.

In accordance with the illustrated embodiments, the messages are only displayed to the user after a seal application has also verified the identity of the site as described above in connection with FIGS. 1-4. System 50 enables verified messages containing site-specific information about a specific provider site to be presented to a user in a series of steps, some of which may occur offline before the user-customized information or seal is presented to the user, and some of which may occur in a final message exchange between the seal application and the seal server. These latter steps may modify the contents of message pair steps 225/230 in FIG. 2 or message pair steps 340/345 in FIG. 3, depending on the type of site authentication performed.

Referring to FIG. 5, via connections 560 and 570, the seal server 500 and provider 540 communicate over a real-time network (typically the Internet) with end-user device 550. In addition, as described below trusted parties such as a brand 510 or card issuer 520 may interact with the seal server 500, the provider 540, and/or a seal application residing on the end-user device 550.

Trusted parties enter into a business relationship with the seal server which allows the trusted parties to digitally sign messages to place on a provider site (i.e., so that they are presented to a user as part of that provider's content). In FIG. 5, the seal server (or a related party on its behalf) provides digital signature software 530 and 531 to trusted parties 520 and 510 respectively. As will be appreciated by those skilled in the art, such software can take different forms. In one embodiment, messages are signed using an HMAC (keyed-Hash Message Authentication Code) algorithm (see for e.g., http://en.wikipedia.org/wiki/HMAC) with a secret shared between the seal server and the trusted party (the seal server using a different secret for each trusted party). In another embodiment, signatures are performed using public key certificate and PKI infrastructure. In a system optimized for cost reduction, the HMAC solution may be preferred owing to the lower computational costs of generating and verifying signatures. On the other hand, in a system that allows for openness, including the possibility of many different seal servers, PKI may be preferred. Other digital signature technologies may also be used.

For the sake of illustration only, the HMAC embodiment is described below. The digital signature software tool takes as input the identity of the provider P, a message M, an expiration date E, and a shared secret SEC_{T,SS}, and it produces as output a message blob MB defined as:

MB_{T}=<P, M, E, T, V>

where V is a verification token (i.e., a digital signature) defined as:

V=HMAC(P+H(M+E), SEC_{T,SS})

The notation MB_{T} refers to a message blob that is signed by trusted party T. It is a 5-tuple consisting of the identity P of the provider, the message string M itself, the expiration date E, the identity T of the trusted party, and the verification token V. In this embodiment, the message string is sent unencrypted and therefore would be visible in the source code of the provider's served content, although that content is still preferably transmitted over a secure SSL connection and therefore is encrypted at the protocol level. In other embodiments, the message string M itself could alternatively be encrypted prior to transmission.

As will be appreciated, instead of an expiration date E, other types of information or data can alternatively be used to verify the timeliness of a message. For example, a third party may use a revocation list. In such a case, the above-described verification token, V, would use a hashed value of M only, i.e., V=HMAC(P+H(M), SEC_{T,SS}).

In the present embodiment: the first argument to the HMAC verification token is the concatenation of the provider identity P with a hash of the message M concatenated with the expiration date E, denoted by H(M+E), where H is a secure hashing function such as SHA-1 or SHA-256. The second argument to the HMAC is a secret SEC_{T,SS} that is shared between the trusted party T and the seal server SS. The HMAC itself uses a secure hashing function. As will be appreciated, the shared secret is a piece of data known only to these parties and may take various different forms such as a password. In other embodiments, a digital signature could be created using a public key infrastructure, using the private key of the trusted party T to sign the remaining data.

In a preferred embodiment, HMAC(P+H(M+E), SEC_{T,SS}) is used instead of HMAC(P+M+E, SEC_{T,SS})—even though the latter would be equally cryptographically secure. This is because verification of the signature, using a message that subsequently travels between the seal application and the seal server, can be done with a message payload that is independent of the length of the verified site-specific message. A further advantage of this embodiment is that the seal server never has access to the entire message. However, HMAC(P+M+E, SEC_{T,SS}) or any other appropriate signature scheme could alternatively be used as a verification token.

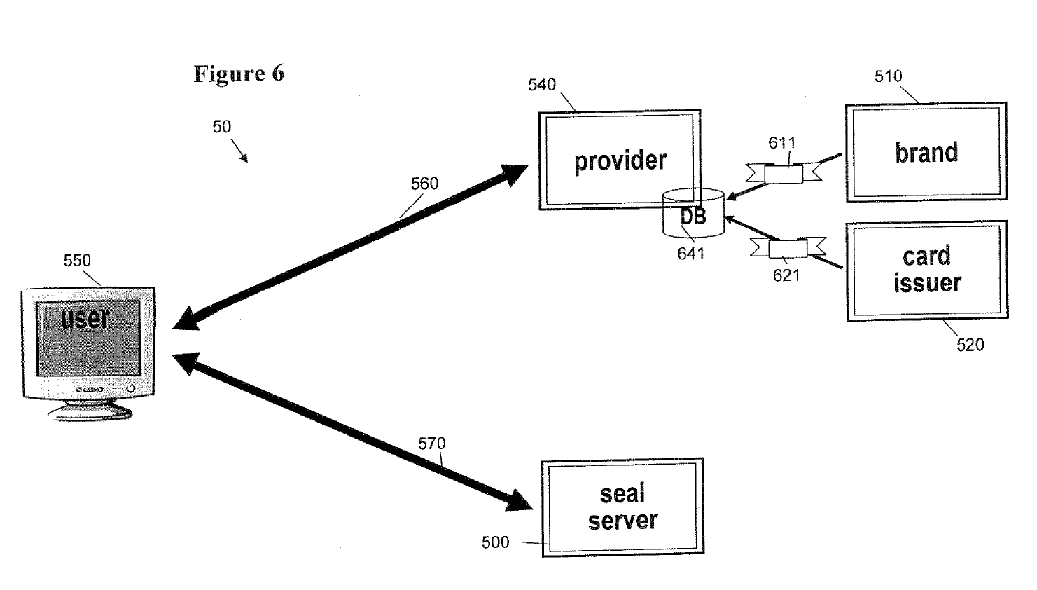

Using the signature tool described above, the trusted parties may sign messages. FIG. 6 shows two such message blobs. Message blob 611 has been signed by trusted party 510 (the brand); it may state, for example, “Provider xyz.com is an authorized retailer for BrandX.” and may expire on a future date when, for instance, a contractual agreement between xyz.com and BrandX terminates. Similarly, message blob 621, from trusted party 520, may state “Site xyz.com is an authorized Visa™ merchant” and it may also expire on some future date specified by party 520.

These two message blobs are sent to provider 540 by any appropriate means such as Web service, e-mail, physical delivery, or any other means available for transferring information. Once at the provider site 540, the provider may insert the messages directly into the content of its Web site, or may optionally store them in a database 641 so that they may be used across multiple Web pages or Web pages that are dynamically generated from database content.

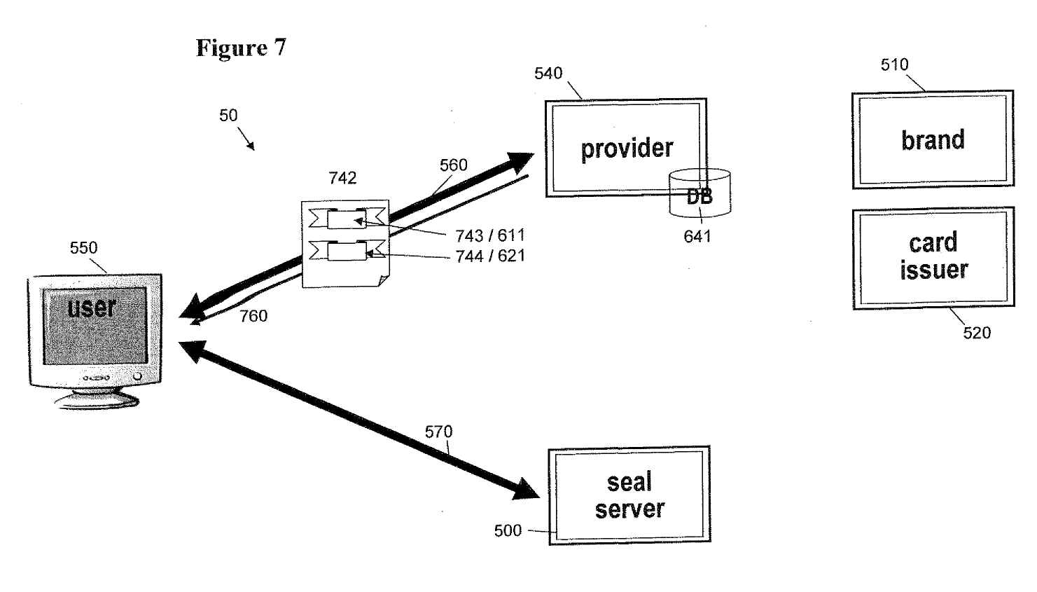

In FIG. 7, the user downloads provider content in the form of a Web page 742, using network message 760 established over Internet connection 560. This page contains message blobs 743 and 744. Message blob 743 is a digital copy of the message blob 611 that was sent from trusted party 510 to provider 540 during the transfer of FIG. 6. Similarly, message blob 744 is a digital copy of message blob 621.

Where system 50 additionally acts as a verification system for authenticating the provider 540 to end-user device 550, the Web page 742 may advantageously be the same page that is downloaded from provider to end-user device in message response 210 of FIG. 2 (or message response 310 of FIG. 3). In this case, message 760 in FIG. 7 corresponds to message 210 of FIG. 2 (or message 310 of FIG. 3). This is preferable since there are no additional messaging steps with respect to the protocols of the verification system of FIGS. 1-4.

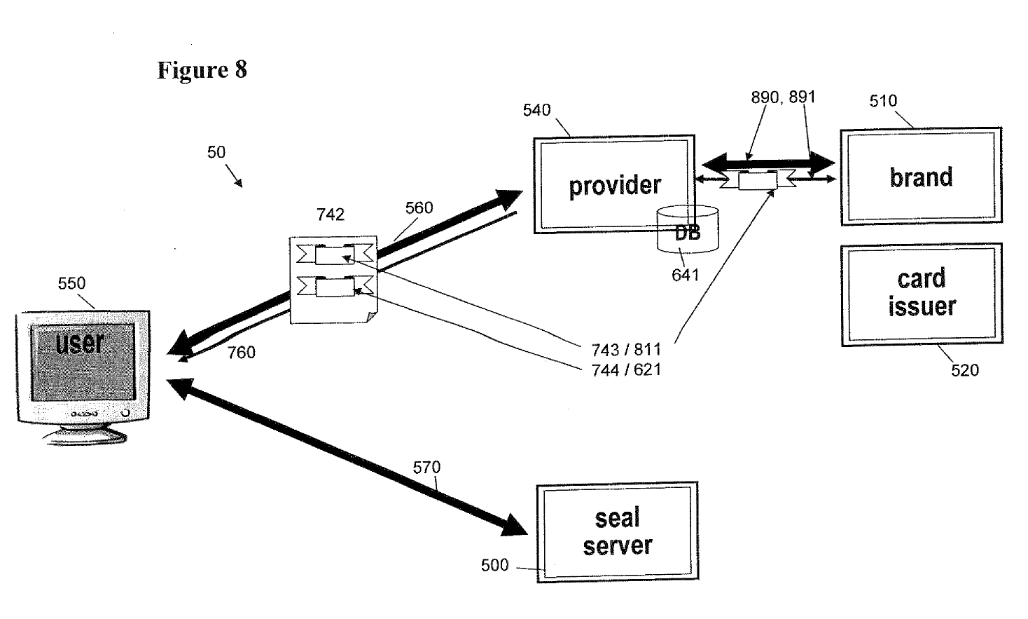

FIG. 8 illustrates a variant of FIG. 7. In certain cases, the message to be included in the response from the provider to the end-user may require gathering some data in real-time from one of the trusted parties. This may include for example, the latest customer feedback information about the provider that is gathered and maintained by the trusted party. In such case, the message blob cannot be pre-signed and stored with provider 540. Such a real-time message blob is shown as message 811, which is requested by provider 540 over network connection 890 using an established bi-directional connection 891. This message blob is then passed directly to the end-user device in page 742. Thus, it will be appreciated that message blob 81 is identical to message blob 743 in FIG. 8.

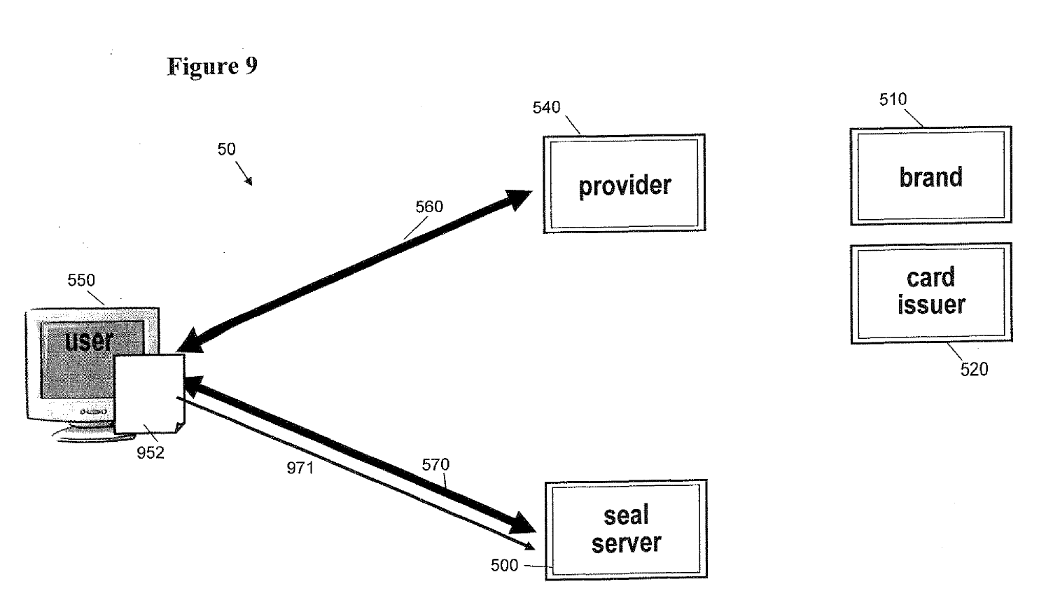

FIGS. 9-11 illustrate how system 50 may additionally act as a verification system for authenticating the provider 540 to end-user device 550. In FIG. 9, the end-user device requests the seal application from the seal server 500, via a link embedded in web page 952, whose content is now resident on the end-user device. This request 971 preferably corresponds to the request 215 in the ladder flow diagram of FIG. 2's ladder diagram (or alternatively to request 315 in FIG. 3).

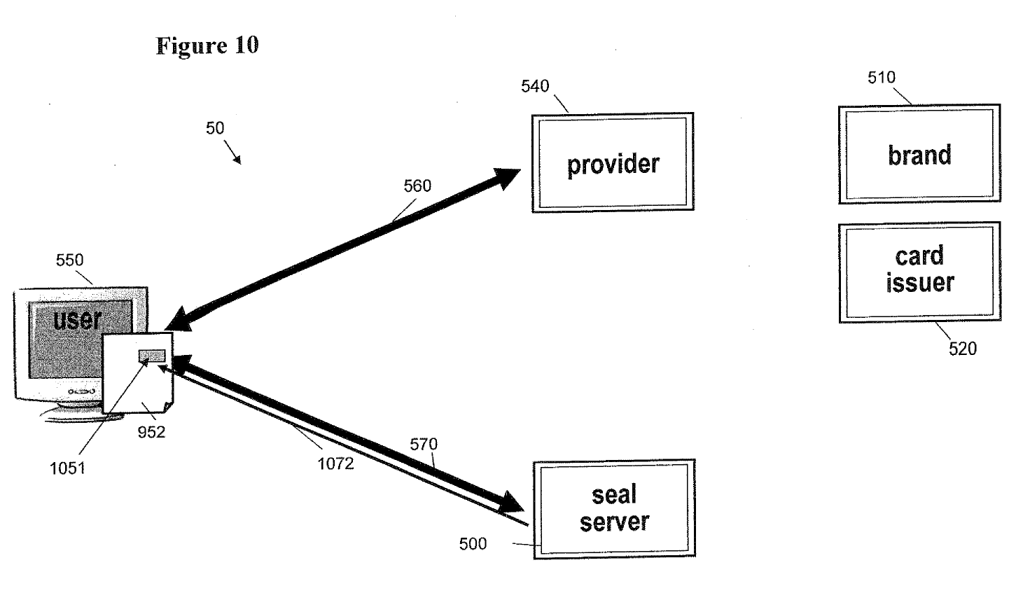

In FIG. 10, the seal server 500 responds with the seal application 1051, which is sent via network message 1072 over Internet connection 570. Again, response 1072 preferably corresponds to the response 220 in FIG. 2 or response 320 in FIG. 3.

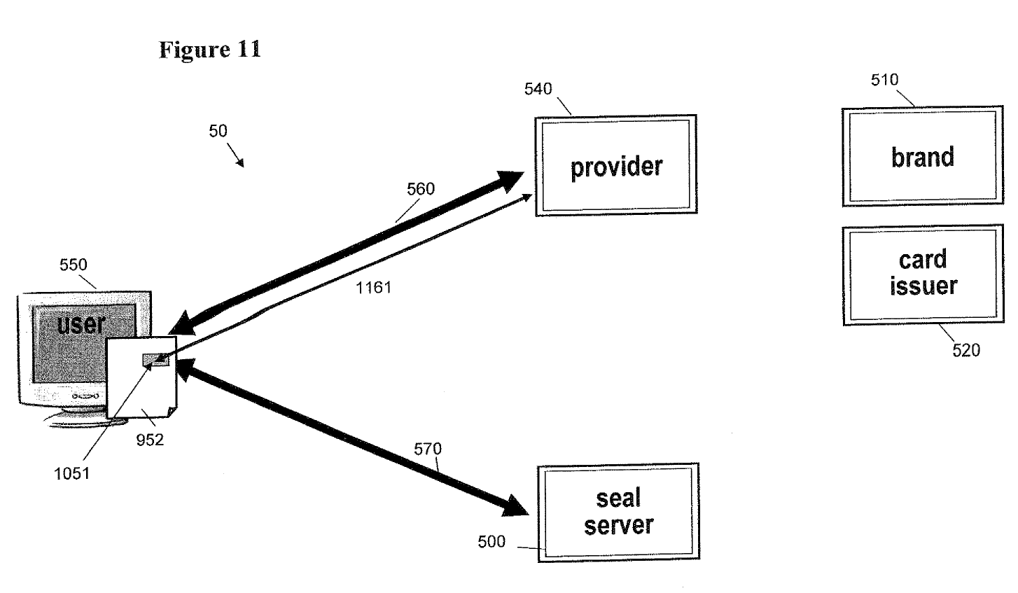

In FIG. 11, the seal application 1051 gathers identity information about the provider's site and then initiates authentication of the identity of the provider as described above. This can take place entirely locally to the end-user device, in which case this step is identical to step 222 of FIG. 2. Alternatively, in a higher authentication level embodiment, the message flows and steps 322, 325, 327, and 330 of FIG. 3 may occur. In this latter case, messages 325 and 330 of FIG. 3 correspond to the bi-directional network connection 1161 in FIG. 11, running over Internet connection 560.

It will be appreciated that the examples of authentication presented in FIGS. 2 and 3 are only indicative of a broad range of possible authentication methods, and that the type of authentication will depend on the level of security required. Furthermore, other existing provider verification systems (in particular those that do not involve the presentation of user-customized information) may also be employed by or used in conjunction with system 50.

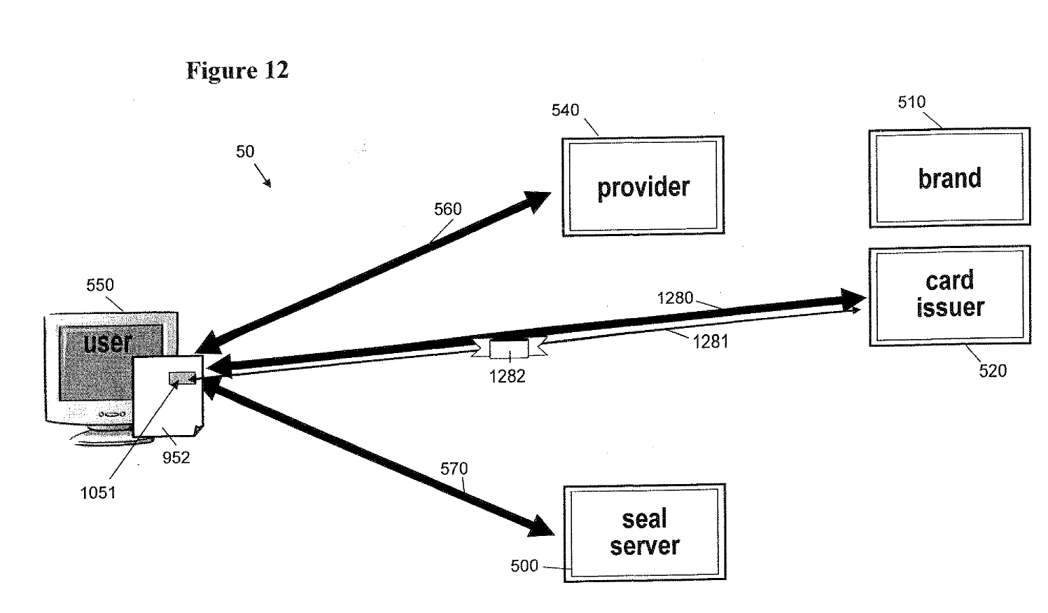

In some embodiments, it may be desirable for the seal application to communicate directly with a trusted party in order to receive a message blob. Such an example is shown in FIG. 12, where the seal application 1051 communicates with trusted party 520 over Internet connection 1280. In this case, the provider embeds within the content of the networked site a request to invoke the seal application to further request the message blob directly from the third party. Seat application 1051 establishes a bi-directional network connection 1281 over which it transmits the identity of the provider P (preferably only after the provider's identity has first been verified) and a request for a specific message type. In response, the trusted party 520 sends a message blob:

MB_{T}<P, M, E, T, V>

where verification token V is:

V=HMAC(P+H(M+E), SEC_{T,SS})

This blob may have exactly the same structure as any other message blob, whether signed in advance and stored with the provider per FIG. 6, created in real-time per FIG. 8, or created in real-time per FIG. 12.

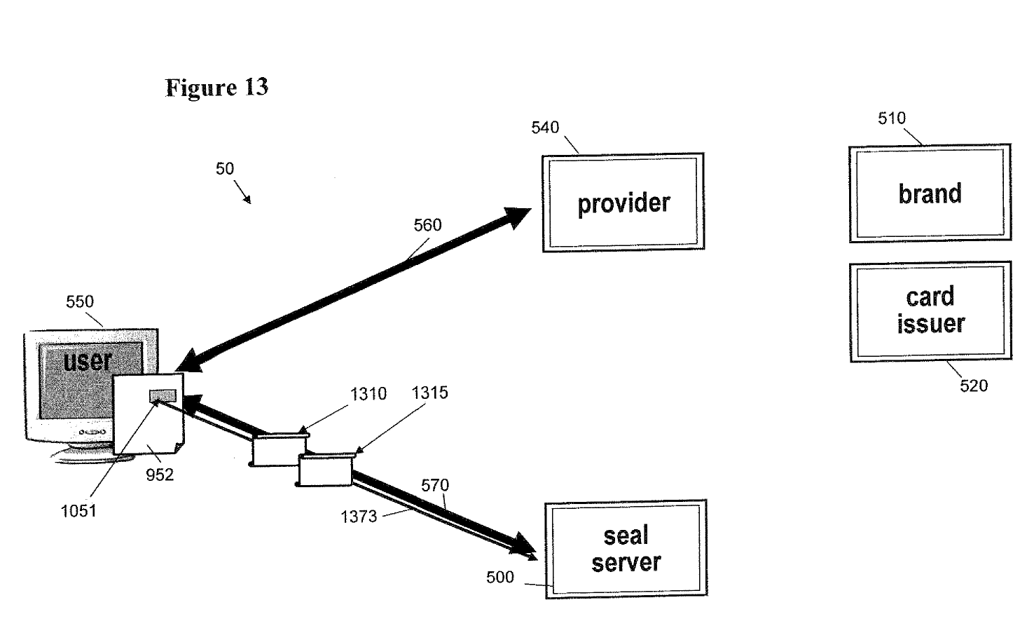

Regardless of how the blob was created and sent to end-user device 550, the seal application 1051 requests verification of the message blob by the seal server 500 as shown in FIG. 13. This occurs via request message 1373 sent over Internet connection 570. This message contains, in part, verification blobs 1310 and 1315. In one embodiment, a verification blob may be identical to a message blob. However, in such a case, long messages would have to be transmitted in their entirety from end-user device 550 to seal server 500. Since client upload connections are often slow, it may be preferable to minimize the size of a verification blob.

In a preferred embodiment, a verification blob is sent as:

VB_{T}=<P, H(M+E), E, T, V)>

The value H(M+E) is independent of the length of message M. In addition, since this value is only a digest, the contents of the message are never revealed to the seal server. To verify the verification blob, the seal server can look up the value of shared secret SEC_{T,SS} based on identity T. With that secret, the seal server can compute the value of

V′=HMAC(P+H(M+E), SEC_{T,SS})

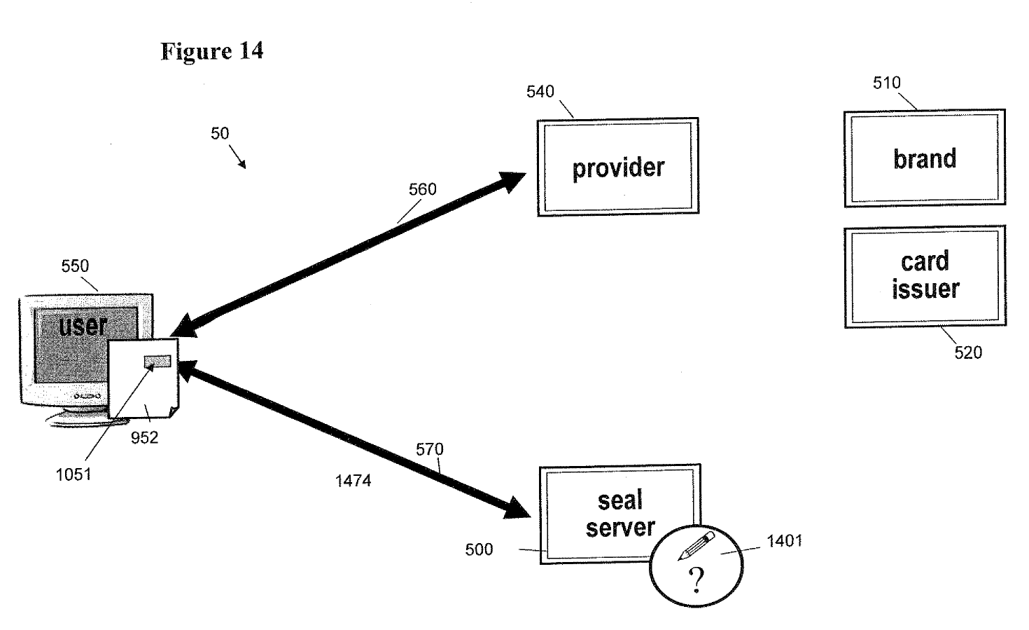

If the following three criteria are met: (i) provider identity P as verified matches the identity used at message blob signature, (ii) V′=V, and (iii) E has not expired, then the verification blob is valid. This verification logic will be used in the description of FIG. 14 below.

Advantageously, message 1373 may correspond to message 225 of FIG. 2 or message 340 of FIG. 3. In this case, is important to note that all the data carried in messages 225 or 340 are also carried in message 1373 of FIG. 13. In this manner, the site verification system described in connection with FIGS. 1-4 has been extended to include verification blobs 1310 and 1315 in the “verification” portion of the payload of message 225 of FIG. 2 (or message 340 of FIG. 3).

In FIG. 14, the verification process is performed by a verifier module 1401 at seal server 500. Specifically verifier module 1401 takes the provider identity P, plus the value H(M+E), and uses them with the appropriate shared secret to compute V′ as describe above. If V′=V for a given H(M+E), then the expiration date E is checked. If E is later than the current time, the verification blob is valid. This logic is an augmentation of the verification step 227 of FIG. 2 (or step 342 of FIG. 3).

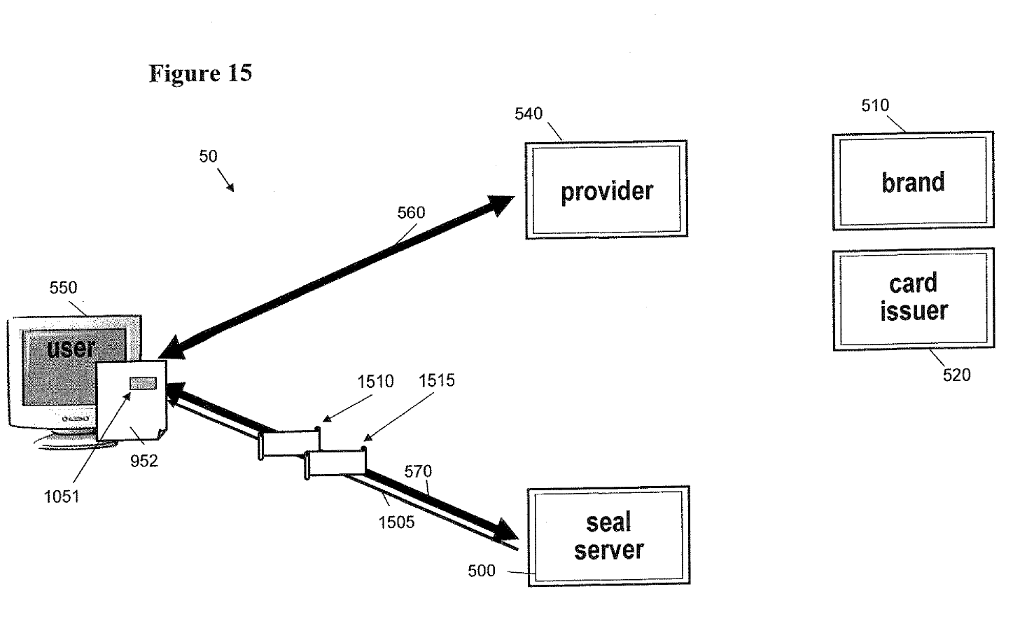

In FIG. 15, the value of H(M+E)—called a return hash—for each verification blob is sent back to the seal application in a return message 1505, over Internet connection 570, if and only if the blob is valid. In this example, both verification blobs have been deemed valid by module 1401, and therefore two return hashes 1510 and 1515 are returned to the seal application 1051.

Again, message 1505 may advantageously correspond to message 230 of FIG. 2 or to message 345 of FIG. 3. In this case, all the data carried in message 230 or 345 are also carried in message 1505 of FIG. 15. In this manner, the site verification system described in connection with FIGS. 1-4 has been extended to include return hashes 1510 and 1515 in the “verified” portion of the payload of message 230 of FIG. 2 (or message 345 of FIG. 3).

Finally, in FIG. 16, the seal application 1051 displays a visual indication as to whether the verification has been successful. In particular, if the provider is authentic, visual indicia 1600 is preferably presented on the end-user device and may include, for example, the seal of FIG. 4 or alternatively just a generic “OK” or “verified” icon. For each return hash 1510, 1515 that was sent, the seal application 105 enables presentation of the corresponding site-specific message (i.e., the site-specific information) to the user. This may occur for instance via a drop-down menu, rollover-activated popup, or click-activated popup.

If the verification of the provider 540 fails in FIG. 16, the visual indicia 1600 would instead show a suitable warning icon instead. In one embodiment, if the seal server verifies the provider's identity but not a message blob, seal application 105 simply blocks the corresponding message or site-specific content from being presented on the end-user device. Alternatively, if the message blob was not authenticated for another reason, the seal application may in some cases present an explicit “failed message” warning. For example, if the expiration date E has already past, such a warning may state “[The provider's name]'s authorization to sell BrandX has expired.”

In all cases, audio or other indicators may also be present.

In this manner relevant site-specific information can be presented to a user in a verified and authentic manner. All such signed messages are funneled through the trusted seal application back to a server for verification of the signatures. Furthermore, since site-specific information is digitally signed, tampering and spoofing of this information is much more difficult.

As a result, the present invention is both more effective and efficient compared to prior art solutions since the trusted parties are, in effect, entities that have already independently vetted the provider 540 via an existing and ongoing relationship. For instance, a brand may not only have vetted the identity of a particular provider 540, but it may also have vetted the provider's business as one that upholds and meets the service standards they require for the sale of their products. Ultimately, this is often the level of trust the end-user or consumer seeks: Is the provider and more particularly the provider's Web site authorized to sell a product of interest? If so, the end-user can be confident in trusting the site. On the other hand, merely knowing that a provider has a legal business somewhere (which is effectively what prior art solutions such as Extended Validation Certificates do) does not engender the same level of trust for the end-user.

In this manner, the invention can be used to help protect users when particular facets of a provider's operation or behavior are not up to standards, rather than just when the operator loses a business license. Thus, for instance, if the provider is not upholding the sales assistance and warranty service required of Brand 1, the verification of the site as a trusted vendor of Brand 1 can be revoked without affecting Brand 2. Similarly, if the site has a history of problems with one credit card brand but not another, the site-specific information for the site may be modified accordingly. Similarly, the invention enables a consumer to see that the provider is still a member of a brand's retailer network or still is a member of a trade association (and has not just copied the association's graphic onto its web site). A brand can sever its ties with the site, revoking its authorized dealer status, without the site losing its business license. The interests of the consumer are served, as they are being spared the prospects of a sub-par or inconsistent buying experience.

While the invention has been described in conjunction with specific embodiments, it is evident that numerous alternatives, modifications, and variations will be apparent to those skilled in the art in light of the foregoing description. For example, while invoking of the seal application via JavaScript was described, the seal application may be invoked using any suitable programming language or script (such as HTML). The local storage of data for the end-user device can be achieved through a variety of means, including local programs, JavaScript, Java, or Flash applications. Moreover, several cryptographic options that can be employed in a variety of ways. Furthermore, although use of the verification system and method described in U.S. patent application Ser. No. 11/850,805 is preferred to initially verify a networked site, in other embodiments other site verification systems may be used in conjunction with system 50.

1. A method of presenting a message relating to a networked site on an end-user device, the method comprising:
at a verification server remote from the end-user device, receiving from the end-user device a request to verify the authenticity of a message blob, the message blob having been received at said end-user device when the end-user device accesses the networked site, the message blob comprising the message and associated verification information, and the message originating from a third party that is not a provider of the networked site;
verifying at the verification server whether the message blob is authentic based on the verification information;
if the message blob is verified as authentic, sending a return message confirming authenticity to the end-user device so that the message can be presented on the end-user device.

2. The method of claim 1, wherein the verification server is remote from servers of both the third party and the provider of the networked site.

3. The method of claim 1, wherein the end-user device receives the message blob directly from the third party.

4. The method of claim 1, wherein the end-user device receives the message blob from the provider as part of the content of the networked site.

5. The method of claim 1, further comprising providing digital signature software and secret information to the third party, said digital signature software and secret information being used to generate, at least in part, the associated verification information.

6. The method of claim 5, wherein the associated verification information comprises information relating to the identity of the third party, information relating to the identity of the provider of the networked site and a digital signature.

7. The method of claim 6, wherein verifying whether the message blob is authentic includes: determining, based on the information relating to the identity of the third party, the secret information provided to the third party; and using said secret information to evaluate the associated verification information.

8. The method of claim 1, wherein the request to verify the authenticity of the message blob comprises a verification blob that is identical to the message blob.

9. The method of claim 1, wherein the request to verify the authenticity of the message blob comprises a verification blob that contains a hashed value of the message.

10. The method of claim 1, further comprising
receiving from the end-user device a request to verify the authenticity of the networked site together with identity information about the networked site; and
verifying whether the networked site is authentic prior to verifying whether the message blob is authentic.

11. The method of claim 1, wherein the return message confirming authenticity comprises a hashed value of the message.

12. A method of presenting a message relating to a networked site on an end-user device, the method comprising:
when the end-user device accesses the networked site, receiving a message blob containing the message and associated verification information, the message originating from a third party that is not a provider of the networked site;
sending a request to verify the authenticity of the message blob to a verification server that is remote from the end-user device; and
if the message blob is verified as authentic by the verification server, enabling presentation of the message on the end-user device.

13. The method of claim 12, wherein the verification server is remote from servers of both the third party and the provider of the networked site.

14. The method of claim 12, wherein the end-user device receives the message blob directly from the third party.

15. The method of claim 12, wherein the end-user device receives the message blob from the provider as part of the content of the networked site.

16. The method of claim 12, wherein the associated verification information comprises information relating to the identity of the third party, information relating to the identity of the provider of the networked site and a digital signature.

17. The method of claim 12, wherein the request to verify the authenticity of the message blob comprises a verification blob that is identical to the message blob.

18. The method of claim 12, wherein the request to verify the authenticity of the message blob comprises a verification blob that contains a hashed value of the message.

19. The method of claim 12, further comprising sending to the verification server a request to verify the authenticity of the networked site together with identity information about the networked site, so that the verification server can verify whether the networked site is authentic prior to verifying whether the message blob is authentic.

20. The method of claim 12, wherein enabling presentation of the message on the end-user device occurs upon receipt of a return message confirming authenticity from the verification server, said return message comprising a hashed value of the message.

21. A system for presenting a message relating to a networked site on an end-user device, the system comprising:
a verification application comprising computer-readable program code residing on an end-user device, the verification application being configured
to send, via the network, a request to verify the authenticity of a message blob received by the end-user device when said end-user device accesses the networked site, the message blob containing the message and associated verification information, and the message originating from a third party that is not a provider of the networked site, and
to enable presentation of the message on the end-user device upon receiving a return message confirming that the message blob is verified as authentic; and
a verification server, remote from the end-user device, configured
to receive, via the network, the request to verify the authenticity of the message blob from the verification application,
to verify whether the message blob is authentic based on the verification information, and
to send the return message confirming authenticity to the verification application if the message blob is verified as authentic.

22. The system of claim 21, wherein the verification server is remote from servers of both the third party and the provider of the networked site.

23. The system of claim 21, wherein the end-user device receives the message blob directly from the third party.

24. The system of claim 21, wherein the end-user device receives the message blob from the provider as part of the content of the networked site.

25. The system of claim 21, wherein the associated verification information is generated, at least in part, from digital signature software and secret information provided to the third party by or on behalf of the verification server.

26. The system of claim 25, wherein the associated verification information comprises information relating to the identity of the third party, information relating to the identity of the provider of the networked site and a digital signature.

27. The system of claim 26, wherein, in order to verify whether the message blob is authentic, the verification server determines the secret information provided to the third party based on the information relating to the identity of the third party, and the verification server uses said secret information to evaluate the associated verification information.

28. The system of claim 21, wherein the request to verify the authenticity of the message blob comprises a verification blob that is identical to the message blob

29. The system of claim 21, wherein the request to verify the authenticity of the message blob comprises a verification blob that contains a hashed value of the message.

30. The system of claim 21, wherein: the verification application is further configured to send, to the verification server, a request to verify the authenticity of the networked site together with identity information about the networked site; and the verification server is further configured to verify whether the networked site is authentic prior to verifying whether the message blob is authentic.

31. The system of claim 21, wherein the return message confirming authenticity comprises a hashed value of the message.

32. A method of presenting a message relating to a networked site on an end-user device, the method comprising:
when a request to serve content of a networked site is received from an end-user device, transmitting the content of the site to the end-user device and further initiating transmission of a message blob to the end-user device, the message blob comprising the message and associated verification information, and the message originating from a third party that is not a provider of the networked site; and
embedding within the content of the networked site a link to invoke a verification application residing on the end-user device, said verification application being configured to communicate with a verification server to enable the server to verify that the message blob is authentic based on the verification information.

33. The method of claim 32, wherein the message blob is served to the end-user device as part of the content of the networked site.

34. The method of claim 33, wherein the message blob is generated dynamically upon receiving the request to serve the content of the networked site and is thereafter inserted as part of said site content.

35. The method of claim 32, wherein initiating transmission of the message blob to the end-user device comprises sending a request to the third party to send the message blob directly to the end-user device.

36. The method of claim 32, wherein initiating transmission of the message blob to the end-user device comprises embedding within the content of the networked site a request to invoke the verification application on the end-user device to further request the transmission of the message blob directly from the third party.

37. The method of claim 32, further comprising: upon the message blob being verified as authentic, presenting the message on the end-user device as part of the content of the networked site.

38. A system for presenting a message relating to a networked site on an end-user device, the system comprising:
a verification application comprising computer-readable program code residing on an end-user device, the verification application being configured
to send, via the network, a request to verify the authenticity of a message blob received by the end-user device from a server of a provider of the networked site when said end-user device accesses the networked site, the message blob containing the message and associated verification information, and
to enable presentation of the message on the end-user device upon receiving a return message confirming that the message blob is verified as authentic; and
a verification server, remote from the end-user device and from the server of the provider of the networked site, configured
to receive, via the network, the request to verify the authenticity of the message blob from the verification application,
to verify whether the message blob is authentic based on the verification information, and
to send the return message confirming authenticity to the verification application if the message blob is verified as authentic.

39. A method of presenting a message relating to a networked site on an end-user device, the method comprising:
at a verification server remote from the end-user device, receiving from the end-user device a request to verify the authenticity of a message blob, the message blob having been received at said end-user device from a server of a provider of the networked site when the end-user device accesses the networked site, the message blob comprising the message and associated verification information, and wherein the verification server is also remote from the server of the provider of the networked site;
verifying at the verification server whether the message blob is authentic based on the verification information;
if the message blob is verified as authentic, sending a return message confirming authenticity to the end-user device so that the message can be presented on the end-user device.
